(19) United States
(12) Patent Application Publication
(10) Pub. No.: US 2026/0156035 A1
(43) Pub. Date: Jun. 4, 2026

(54) POLICY BASED ACTIVATION OF CAPABILITIES

(71) Applicant: Nokia Technologies Oy, Espoo (FI)

(72) Inventors: Borislava GAJIC, Munich (DE); Shu Qiang SUN, Chengdu (CN); Stephen MWANJE, Munich (DE)

(21) Appl. No.: 19/125,470

(22) PCT Filed: Nov. 4, 2022
(86) PCT No.: PCT/CN2022/129728

§ 371 Date: Apr. 29, 2025

(51) Int. Cl. H04L 41/0894; H04L 41/16

(52) U.S. Cl. CPC H04L 41/0894; H04L 41/16

(57) ABSTRACT

Example embodiments of the present disclosure relate to policy based activation of capabilities. A first apparatus determines an activation policy for activating a set of capabilities of a network entity at a second apparatus. The first apparatus sends the determined activation policy to the second apparatus. The first apparatus receives status information on execution of the activation policy from the second apparatus. And the first apparatus updates the activation policy based on the received status information. In this way, it is possible to enable higher level of automation in the AI/ML capabilities activation process, and possible to allow less control on the activation process by the first apparatus.

### FIELD

Example embodiments of the present disclosure generally relate to the field of telecommunication, and in particular, to apparatuses, methods, and a computer readable storage medium for policy based activation of capabilities of a network entity.

### BACKGROUND

Artificial intelligence (AI) and/or machine learning (ML) techniques are being increasingly employed in 5G systems and will find wide application in future systems such as 6G. AI/ML techniques have been proposed for implementing network data analytics functions (NWDAF) in 3GPP 5G cores and management data analytics services (MDAS) in 3GPP Operation, Administration and Management (OAM).

The technical specification 3GPP TS 28.105, release 17 specifies AI/ML management related capabilities and services focusing mainly on AI/ML training. The ongoing technical report 3GPP TR 28.908 aims at discussing the use cases, potential requirements and possible solutions for management of further AI/ML capabilities such as AI/ML validation, testing, deployment, configuration and performance evaluation.

### SUMMARY

In general, example embodiments of the present disclosure provide a solution for configurations for policy based activation of capabilities of a network entity, for example, AI/ML capabilities. Specifically, the solution can enable an automated and gradual AI/ML capability activation.

In a first aspect, there is provided a first apparatus. The first apparatus may comprise at least one processor; and at least one memory storing instructions that, when executed by the at least one processor, cause the first apparatus to: determine an activation policy for activating a set of capabilities of a network entity at a second apparatus; send the determined activation policy to the second apparatus; receive status information on execution of the activation policy from the second apparatus; and update the activation policy based on the received status information.

In a second aspect, there is provided a second apparatus. The second apparatus may comprise at least one processor; and at least one memory storing instructions that, when executed by the at least one processor, cause the second apparatus to: receive, from a first apparatus, an activation policy for activating a set of capabilities of a network entity at the second apparatus; execute the activation policy to obtain status information on execution of the activation policy; send the status information to the first apparatus; and receive an updated activation policy from the first apparatus.

In a third aspect, there is provided a method at a first apparatus. The method may comprise determining an activation policy for activating a set of capabilities of a network entity at a second apparatus; sending the determined activation policy to the second apparatus; receiving status information on execution of the activation policy from the second apparatus; and updating the activation policy based on the received status information.

In a fourth aspect, there is provided a method at a second apparatus. The method may comprise receiving, from a first apparatus, an activation policy for activating a set of capabilities of a network entity at the second apparatus; executing the activation policy to obtain status information on execution of the activation policy; sending the status information to the first apparatus; and receiving an updated activation policy from the first apparatus.

In a fifth aspect, there is provided a first apparatus. The first apparatus may comprise: means for determining an activation policy for activating a set of capabilities of a network entity at a second apparatus; means for sending the determined activation policy to the second apparatus; means for receiving status information on execution of the activation policy from the second apparatus; and means for updating the activation policy based on the received status information.

In a sixth aspect, there is provided a second apparatus. The second apparatus may comprise: means for receiving, from a first apparatus, an activation policy for activating a set of capabilities of a network entity at the second apparatus; means for executing the activation policy to obtain status information on execution of the activation policy; means for sending the status information to the first apparatus; and means for receiving an updated activation policy from the first apparatus.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by a first apparatus, cause the first apparatus at least to: determine an activation policy for activating a set of capabilities of a network entity at a second apparatus; send the determined activation policy to the second apparatus; receive status information on execution of the activation policy from the second apparatus; and update the activation policy based on the received status information.

In a ninth aspect, there is provided a computer program comprising instructions, which, when executed by a second apparatus, cause the second apparatus at least to: receive, from a first apparatus, an activation policy for activating a set of capabilities of a network entity at the second apparatus; execute the activation policy to obtain status information on execution of the activation policy; send the status information to the first apparatus; and receive an updated activation policy from the first apparatus.

In a tenth aspect, there is provided a first apparatus. The first apparatus comprises determining circuitry configured to: determine an activation policy for activating a set of capabilities of a network entity at a second apparatus; sending circuitry configured to: send the determined activation policy to the second apparatus; receiving circuitry configured to: receive status information on execution of the activation policy from the second apparatus; and updating circuitry configured to: update the activation policy based on the received status information.

In an eleventh aspect, there is provided a second apparatus. The second apparatus comprises receiving circuitry configured to: receive, from a first apparatus, an activation policy for activating a set of capabilities of a network entity at the second apparatus; executing circuitry configured to: execute the activation policy to obtain status information on execution of the activation policy; sending circuitry configured to: send the status information to the first apparatus; and receiving circuitry configured to: receive an updated activation policy from the first apparatus.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example environment in which example embodiments of the present disclosure may be implemented;

FIG. 2 illustrates an example signaling process for policy based activation of AI/ML capabilities in accordance with some embodiments of the present disclosure;

FIG. 3 illustrates an example signaling process for step-based activation of AI/ML capabilities in accordance with some embodiments of the present disclosure;

FIG. 4 illustrates an example signaling process for rule-based activation of AI/ML capabilities in accordance with some embodiments of the present disclosure;

FIG. 5 illustrates an example signaling process for intent-based activation of AI/ML capabilities in accordance with some embodiments of the present disclosure;

FIG. 6 illustrates an example signaling process for activation request-based activation of AI/ML capabilities in accordance with some embodiments of the present disclosure;

FIG. 7 illustrates an example diagram of scope profiles in accordance with some embodiments of the present disclosure;

FIG. 8 illustrates an example flowchart of a method implemented at a first apparatus in accordance with some example embodiments of the present disclosure;

FIG. 9 illustrates an example flowchart of a method implemented at a second apparatus in accordance with some example embodiments of the present disclosure;

FIG. 10 illustrates an example simplified block diagram of an apparatus that is suitable for implementing embodiments of the present disclosure; and

FIG. 11 illustrates an example block diagram of an example computer readable medium in accordance with some embodiments of the present disclosure;

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components /d/ or combinations thereof.

The terms artificial intelligence and/or machine learning (AI/ML) refer to software-implemented methods based on mathematical algorithms or models providing an inference function. Such models are typically mathematical algorithms, trained with information and that replicate a decision an expert would make when provided that same information. According to some embodiments, AI/ML functions may also provide data analytics. An AI/ML training function associated e.g., with a model takes data, runs the data through the AI/ML model and derives the associated loss and adjusts the parameterization of that AI/ML model based on the computed loss. Training methods may include supervised learning, unsupervised learning and reinforcement learning, and training may be performed offline or be continuous. The inference function can be one of a number of known categories, such as regression-based, clustering- or association based, reward-based behavior, with an appropriate training method being applied.

Example applications of AI and/or ML comprise without limitation: voice recognition; image processing/computer vision; natural language processing; information retrieval; personalization and recommendation; robotics, data analytics including predictive and prescriptive analytics; use-cases for the design and/or planning and/or optimization and/or configuration and/or control and/or management of communication systems and / or networks.

Example use-cases may be without limitation:
use-cases related to the physical-layer of communication networks such as modulation, coding, decoding, signal detection, channel estimation, prediction, compression, interference mitigation;
use-cases related to the medium access control layer of communication networks such as multiple access and resource allocation (e.g., power control, scheduling, spectrum management);
channel modeling;
network optimization;
cell capacity estimation in cellular networks;
routing;
resource management;
data traffic management;
security and anomaly detection;
root cause analysis;
transport protocol design and optimization;
user/network/application behavior analysis/prediction;
transport-layer congestion control;
user experience modeling and optimization;
user mobility and positioning management;
network slicing, network virtualization and software defined networking;
non-linear impairments compensation in optical networks (e.g., visible-light communications, fiber-optics communications, and fiber-wireless converged networks), and
quality-of-transmission estimation and optical performance monitoring in optical networks.

The term AI/ML entity designates any network entity that contains one or more AI and/or ML capabilities. Example network entities comprise without limitation:
radio access network entities such as base stations (e.g., cellular base stations like eNodeB in LTE and LTE-advanced networks and gNodeB used in 5G networks, and femtocells used at homes or at business centers);
relay stations;
control stations (e.g., radio network controllers, base station controllers, network switching sub-systems);
access points in local area networks or ad-hoc networks;
gateways and radio access network entities;
network management entities (e.g., Operation, Administration and Management (OAM) entity);
network automation systems;
distributed analytics entities such as self-autonomous systems (D-SONs);
network functions (e.g., network data analytics function, NWDAF, defined in current 3GPP standards);
user equipment (UE).

An AI/ML Management Service (MnS) producer, e.g., a network or management function within a network entity, applies AI/ML to accomplish specific tasks. The AI/ML Management Service (MnS) is considered to comprise one or more AI/ML entities, each having specific AI/ML capabilities.

In some example embodiments, an MnS is a set of offered capabilities for management and orchestration of network and services. The entity producing an MnS is called an MnS producer. The entity consuming an MnS is called an MnS consumer. An MnS provided by an MnS producer can be consumed by any entity with appropriate authorization and authentication.

An AI/ML entity provides capabilities to an AI/ML MnS consumer through an AI/ML MnS producer. Example outputs of an AI/ML entity capability comprise decisions or data analytics. Example analytics and/or decision functions comprise without limitation: coverage analysis, coverage problems analysis, handover problems analysis, faults detection, interference detection, coverage optimization, capacity optimization, handover optimization, interference reduction, energy saving optimization. The AI/ML MnS producer may be a function that may be implemented through software and/or hardware by any appropriate network entity (e.g. a network management function, an automation function, an analytics function, or a network function like a gNB, or cell) configured to provide an interface for AI/ML capability exposure on behalf of one or more AI/ML entities. The AI/ML MnS consumer may be a function that may be implemented by any network entity. In more embodiments, the MnS consumer is required to have appropriate authorization and authentication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

The inventors have noticed that current solutions for AI/ML entity activation assume that the activation of AI/ML capabilities will unconditionally improve the network performance. However, it is difficult to predict or determine benefits and difficult to quantify such benefits of using AI/ML capability in a given context of operational network before actually using it.

A solution for gradual activation of AI/ML capability provides means to gradually assess the benefits of AI/ML capability activation in operational environment, but it opens a question on what is the most efficient split in responsibilities between AI/ML consumer and AI/ML producer during activation procedure. If the activation procedure is entirely relying on the AI/ML consumer to micro-manage every activation step, such process may require extensive signaling between AI/ML consumer and AI/ML producer and intrinsically lacks the automation potential.

On the other hand, the activation procedure cannot be left up fully to the producer either, as the producer may not have a whole view of other AI/ML entities or AI/ML capabilities that are currently in operation, activated by different producers on the request from consumer. The producer needs to be instructed by the consumer on the ways to perform the adequate activation of AI/ML capabilities.

Therefore, the present disclosure proposes a solution for how to enable the automated AI/ML capability activation and how to enable producer to perform gradual activation on behalf of AI/ML consumer.

Example embodiments of the present disclosure provide a mechanism for policy based activation of capabilities of a network entity, for example, for allowing an AI/ML consumer to provide the activation policies to instruct an AI/ML producer on how to automatically activate the AI/ML capabilities in the operational environment. The example embodiments of the present disclosure can provide means for automating the gradual activation. Principles and some example embodiments of the present disclosure will be described in detail below with reference to the accompanying drawings.

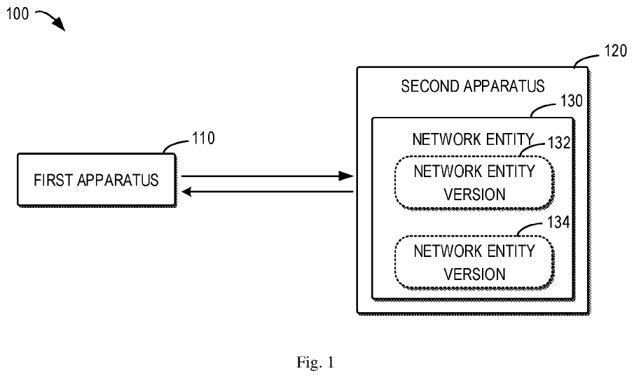

FIG. 1 illustrates an example environment 100 in which example embodiments of the present disclosure may be implemented. In the descriptions of the example embodiments of the present disclosure, the network 100 comprises a first apparatus 110 and a second apparatus 120. In some example embodiments, the first apparatus 110 and the second device 120 may be network devices, core network devices, radio access network devices, relay stations, control stations, network management entities, or terminal devices.

The second apparatus 120 comprises a network entity 130. The network entity 130 may be an AI/ML entity comprising an AI/ML function, implemented by e.g., an AI/ML model. The AI/ML model can be obtained by applying different training approaches or different training data, and thus a particular AI/ML model can be called an network entity version, such as network entity version 132 and network entity version 134.

The first apparatus 110 can request activation of one or more AI/ML capabilities of the network entity by sending an appropriate policy to the second apparatus 120. Status information on execution of the policy can be sent by the second apparatus 120 to the first apparatus 110. The first apparatus 110 and the second apparatus 120 can also interact with each other for other matters.

Various aspects of example embodiments will be described in the context of one consumer, and one producer that communicate with one another. It should be appreciated, however, that the description herein may be applicable to other types of apparatus or other similar apparatuses that are referenced using other terminology.

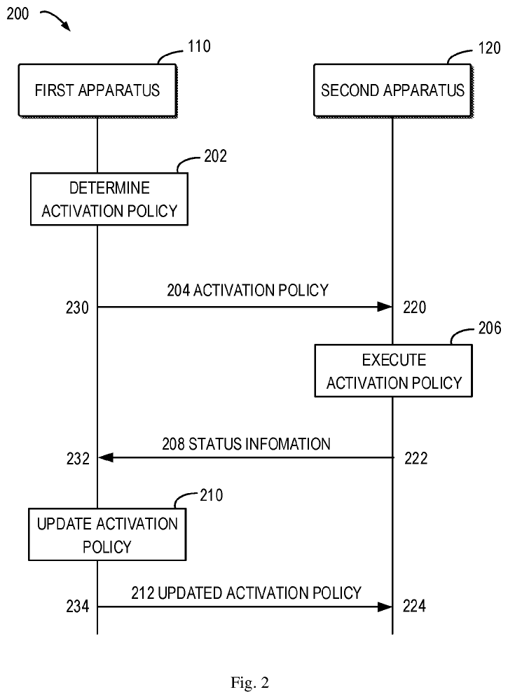

Reference is made to FIG. 2, which illustrates an example signaling process 200 for policy based activation of AI/ML capabilities in accordance with some embodiments of the present disclosure. In FIG. 2, the first apparatus 110 and the second apparatus 120 are taken as an example to illustrate the example process. However, it is just for illustrative purposes without limiting the present disclosure in any way.

At block 202, the first apparatus 110 determines an activation policy. The activation policy may be divided into two types. One is interactive policy approach, and another one is non-interactive policy approach. Each approach may correspond to a mode in which the first apparatus 110 interacts with the second apparatus 120 for activation.

For the interactive policy approach, the activation policy provides and supports an automated activation process by allowing the first apparatus 110 to iteratively evaluate the outcomes of each level of activation before proceeding to the next level. For example, the first apparatus 110 interacts with the producer by requesting activation status information and further controlling the activation based on received status information.

For the non-interactive policy approach, in some example embodiments, the first apparatus 110 provides activation rules, expectations, targets or intents as guidelines to guide behaviours of the second apparatus 120. Based on the received guidelines, the second apparatus 120 takes over the control on activation process in order to fulfil the first apparatus 110's requirements.

In some example embodiments, the first apparatus 110 and the second apparatus 120 may obtain information on AI/ML capabilities of a network entity 130. The first apparatus 110 may determine an activation policy based on the obtained information on AI/ML capabilities of a network entity 130. Such information may be a plurality of capabilities of network entity 130. A set of capabilities may be at least part of the plurality of capabilities.

As an example, the second apparatus 120 may expose the information on AI/ML capabilities of an AI/ML entity. Such exposure may be done as a response to query from the first apparatus 110 or may be initiated by the second apparatus 120. AI/ML capabilities may refer to decision or analytics. For example, capabilities of an AI/ML entity as a decision may be described as a triplet <object(s), parameters, metrics> with the entries respectively indicating: the object or object types for which the AI/ML entity can undertake optimization or control; the configuration parameters of the stated object or object types, which the AI/ML entity optimizes or controls to achieve the desired outcomes; and the network metrics which the AI/ML entity optimizes through its actions.

Similarly, capabilities of an AI/ML entity as analytics may be described as a tuple <object(s), characteristics> with the entries respectively indicating: the object or object types for which the AI/ML entity can undertake analytics; and the network characteristics (related to the stated object or object types) for which the AI/ML entity produces analytics.

The first apparatus 110 sends 230 the determined activation policy 204 to the second apparatus 120. The second apparatus 120 receives 220 the determined activation policy 204 from the first apparatus 110. As an example, the first apparatus 110 sends an instruction that activating 10% of the AI/ML capability to the second apparatus 120. The second apparatus 120 receives the instruction from the first apparatus 110.

At block 206, the second apparatus 120 executes the received activation policy 204. As an example, the second apparatus 120 activates the 10% of the AI/ML capability by executing the received instruction.

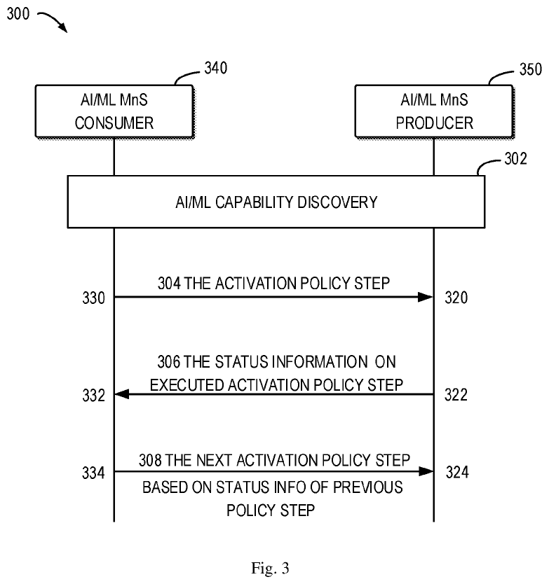

The second apparatus 120 sends 222 status information 208 to the first apparatus 110. The first apparatus 110 receives 232 the status information 208 from the second apparatus 120. Depending on different activation policy, the status information 208 may be different, which will be discussed with reference with FIG. 3 to FIG. 6 hereafter.

At block 210, the first apparatus 110 updates the activation policy 204 based on the received status information 208. The first apparatus 110 sends 234 the updated activation policy 212 to the second apparatus 120. The second apparatus 120 receives 224 the updated activation policy 212 from the first apparatus 110.

By means of such proposed solution as proposed herein, it is possible to enable higher level of automation in the AI/ML capabilities activation process. It is also possible to allow less control on the activation process by a first apparatus.

Reference is made to FIG. 3, which illustrates an example signaling process 300 for step-based activation of AI/ML capabilities in accordance with some embodiments of the present disclosure. FIG. 3 is an example embodiment of FIG. 2. In FIG. 3, the first apparatus 110 may be an AI/ML consumer 340 (referred to consumer 340 hereafter), and the second apparatus 120 may be an AI/ML producer 350 (referred to producer 350 hereafter). In FIG. 3, the activation policy is an activation policy step of a step-based policy.

At block 302, AI/ML capabilities discovery is performed between the consumer 340 and the producer 350. As an example, the producer 350 exposes the information on AI/ML capabilities of an AI/ML Entity. Such exposure may be done as a response to query from the consumer 340 or may be initiated by the producer 350.

The consumer 340 may define an activation policy step 304 by specifying a set of AI/ML capabilities to be activated. For example, the consumer 340 may specify an activation scope, or a window. The consumer 340 may further specify network performance metrics of interest, which need to be monitored and reported by producer 350, and the time window in which the performance needs to be monitored before sending reports. The consumer 340 may send 330 the activation policy step 304 to the producer 350.

The producer 350 may receive 320 the activation policy step 304 from the consumer 340. The producer 350 may execute the received activation policy step 304. The producer 350 may provide 322 the status information 306 on executed activation policy step 304. In some example embodiments, the status information 306 may comprise the following:
Activation status: success or failed
Activated AI/ML capabilities description
Activation scope description
Report on metrics or changes as requested by the consumer

The consumer 340 may receive 332 the status information 306. The consumer 340 may define the next activation policy step based on the information reported by the producer 350 regarding the activation of the previous policy step. The next activation policy step may, for example, comprise extended set or changed AI/ML capabilities. In another example, the next activation policy step may be extended or changed scope. This process of defining the next activation policy steps based on the received feedback may be performed in iterations until the desired capabilities in desired scope is activated and/or the desired metrics are achieved.

The step-based activation policy belongs to the interactive policy approach. The step-based activation policy provides and supports a conservative automated activation process by allowing the consumer to iteratively evaluate the outcomes of each level of activation before proceeding to the next level. Therefore, it is more flexible and gradually activates the AI/ML capabilities in a finer manner.

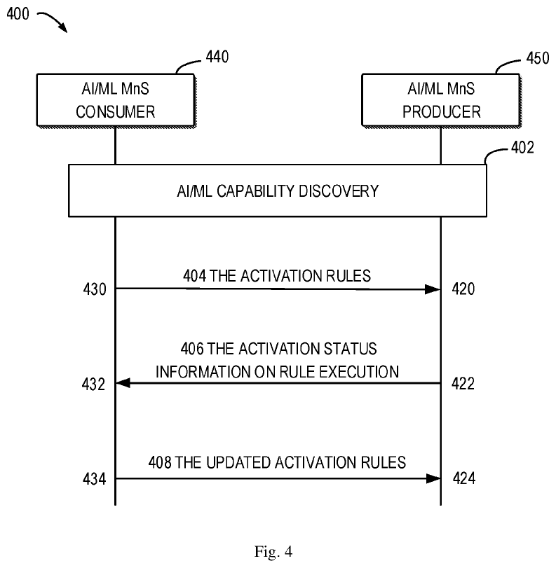

Reference is made to FIG. 4, which illustrates an example signaling process 400 for rule-based activation of AI/ML capabilities in accordance with some embodiments of the present disclosure. FIG. 4 is an example embodiment of FIG. 2. In FIG. 4, the first apparatus 110 may be an AI/ML consumer 440 (referred to consumer 440 hereafter), and the second apparatus 120 may be an AI/ML producer 450 (referred to producer 450 hereafter). In FIG. 4, the activation policy comprises a rule-based policy based on at least one activation rule.

At block 402, AI/ML capabilities discovery is performed between the consumer 440 and the producer 450. As an example, the producer 450 exposes the information on AI/ML capabilities of an AI/ML Entity. Such exposure may be done as a response to query from the consumer 440 or may be initiated by the producer 450.

The consumer 440 may define activation rules 404 under which the available AI/ML capabilities shall be activated by the producer 450. Such rules may comprise a complete set of AI/ML capabilities that shall be activated, the largest desired activation scope or target activation scope as well as the activation constraints or conditions. Such constraints may be expressed in terms of network performance conditions, the order or priority of AI/ML capability activation, preferences in terms of time and geolocation for activation, and further information on preferred or prioritized entities (such as UEs, network slices), etc. to take into account during activation process.

The consumer 440 may send 430 the activation rules 404 to the producer 450. The producer 450 receives 420 the activation rules 404 from the consumer 440. The producer 450 may follow the rules as guidelines. As an example, in order to activate the AI/ML capabilities, the producer 450 may execute the activation rules 404.

The producer 450 may provide 422 the activation status information 406 on rule execution. In some example embodiments, as all needed instructions are available at the producer's side, the activation process may be performed to a large extent autonomously, i.e., without the need for interaction with the consumer 440. In a case of major deviations in activation conditions, a status report may be sent to the consumer 440, along with the information on a critical circumstance, e.g., the deviations in metrics of conditions for execution of activation rules.

The consumer 440 may receive 432 the activation status information 406. Based on received activation status information 406, the consumer 440 may decide to update the activation rules in order to overcome the issues. The consumer 440 may send 434 the updated activation rules 408 to the producer 450. The producer 450 may receive the updated activation rules 408 from the consumer 440.

The rule-based activation policy belongs to the non-interactive policy approach. This rule-based activation policy can provides higher level automated process for the AI/ML capabilities activation process. This process does not need to be instructed step-by-step by the consumer on the ways to perform the adequate activation of AI/ML capabilities.

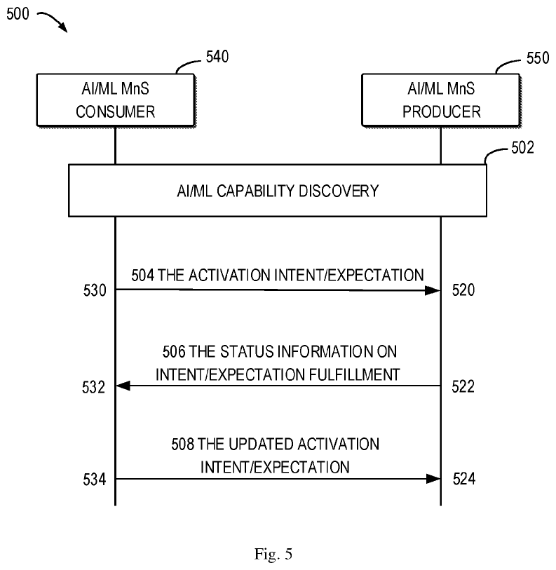

Reference is made to FIG. 5, which illustrates an example signaling process 500 for intent-based activation of AI/ML capabilities in accordance with some embodiments of the present disclosure. FIG. 5 is an example embodiment of FIG. 2. In FIG. 5, the first apparatus 110 may be an AI/ML consumer 540 (referred to consumer 540 hereafter), and the second apparatus 120 may be an AI/ML producer 550 (referred to producer 550 hereafter). In FIG. 5, the activation policy comprises an intent-based policy.

At block 502, AI/ML capabilities discovery is performed between the consumer 540 and the producer 550. As an example, the producer 550 exposes the information on AI/ML capabilities of an AI/ML Entity. Such exposure may be done as a response to query from the consumer 540 or may be initiated by the producer 550.

The consumer 540 may define activation expectations or intents for AI/ML capability activation. The expectations or intents may be expressed, for example, in terms of desired improvements of the target for specific network performance metrics, under specific circumstances (e.g., time window, geographical area and so on).

The consumer 540 may send 530 the activation expectations or intents 504 to the producer 550. The producer 550 may receive 520 the activation expectations or intents 504 from the consumer 540. The producer 550 may execute the activation expectations or intents 504, and may obtain the status information 506 on fulfilments of the activation expectations or intents 504 by activation of the AI/ML capabilities. This may comprise the information on successfully reached targets for network performance metrics, or the deviations or inability in fulfilling the expectations or intents 504.

The producer 550 may provide 522 the status information 506 to the consumer 540. The consumer 540 may receive 532 the status information 506 on activation intents or expectations fulfillment. Based on these feedbacks received from the producer 550, the consumer 540 may update the activation expectations or intents with respect to AI/ML activation. The consumer 540 may also change the expectations or intents with respect to AI/ML activation. The consumer 540 may send 534 the updated expectations or intents 508 to the producer 550. The producer 550 may receive 524 the updated activation expectations or intents 508 from the consumer 540.

The intent-based activation policy belongs to the non-interactive policy approach. Thus, this intent-based activation policy can also provide higher level automated process for the AI/ML capabilities activation process. This process does not need to be instructed step-by-step by the consumer on the ways to perform the adequate activation of AI/ML capabilities. This process makes the producer taking over the control on activation process in order to fulfil the consumer's requirements.

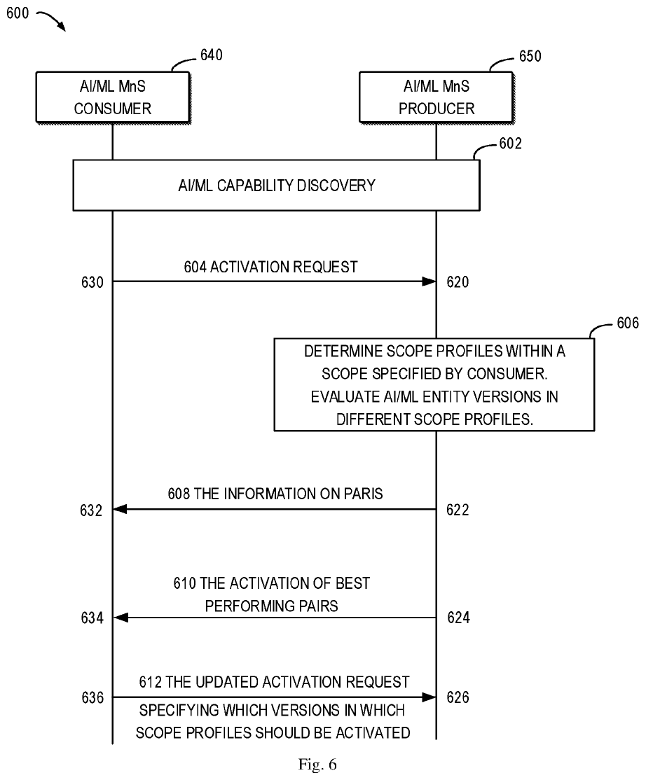

Reference is made to FIG. 6, which illustrates an example signaling process 600 for activation request-based activation of AI/ML capabilities in accordance with some embodiments of the present disclosure. FIG. 6 is an example embodiment of FIG. 2. In FIG. 6, the first apparatus 110 may be an AI/ML consumer 640 (referred to consumer 640 hereafter), and the second apparatus 120 may be an AI/ML producer 650 (referred to producer 650 hereafter). In FIG. 6, the activation policy comprises an activation request for activation of a version of the network entity or activation of at least one capability of the network entity in an activation scope.

The present disclosure proposes procedures for evaluation of AI/ML entities in predefined scope profiles. Scope profiles may represent subsets of the entire scope in which the AI/ML entity may be activated. Scope profiles may also represent distinctive or fixed subset of the entire scope in which the AI/ML entity may be applicable.

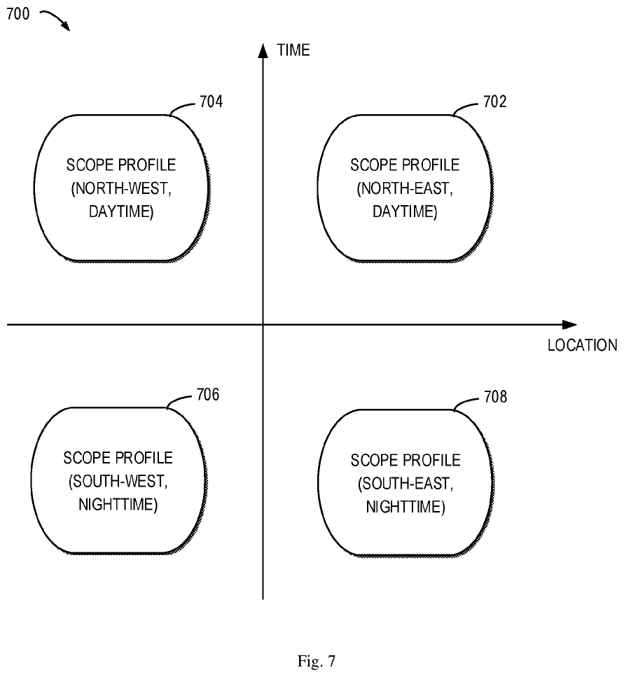

Reference is made to FIG. 7, which illustrates an example diagram 700 of scope profiles in accordance with some embodiments of the present disclosure. As shown in FIG. 7, the four subsets of scope profiles defined over two scope dimensions, time and location. The scope profiles are characterized with the pre-defined values or value ranges of the scope dimensions or information. It is noted that further scope dimensions may be taken into account when defining the scope profiles. A whole set of scope profiles may be grouped into four subsets. The subset 702 comprises scope profiles of northeast in location dimension and daytime in time dimension. The subset 704 comprises scope profiles of northwest in location dimension and daytime in time dimension. The subset 706 comprises scope profiles of southwest in location dimension and nighttime in time dimension. The subset 708 comprises scope profiles of southeast in location dimension and nighttime in time dimension. It is understood that this is an example dimensions for grouping the scope profiles, there are other dimensions for grouping the scope profiles, such as object, object types, or network context, etc.

Referring back to FIG. 6, The AI/ML capabilities and versions of AI/ML entities may be activated for performance evaluation purpose in different scope profiles in a one-by-one manner.

Versions of AI/ML entities may be obtained by applying different training approaches or different training data. For example, different versions of the AI/ML entity may be used for the same analytics, but trained in different ways. Concurrent running of multiple AI/ML entities versions may be allowed in pre-defined scope profile (such as time or/and other domain control, forming a scope profile).

This provides an insight on the best performing pair of AI/ML entity version and scope profile. Based on this information, a better switch-over between different AI/ML entity versions in required scope profiles can be made, and the activation of AI/ML entity and capabilities may rely on the information on the best performing pair.

At block 602, AI/ML capabilities discovery is performed between the consumer 640 and the producer 650. As an example, the producer 650 exposes the information on AI/ML capabilities of an AI/ML Entity. Such exposure may be done as a response to query from the consumer 640 or may be initiated by the producer 650.

The consumer 640 may issue 630 an activation request 604 for activation of certain AI/ML entity or specific capabilities in a certain scope. The producer 650 may receive 620 the activation request 604. The producer 650 may derive different scope profiles out of entire scope defined by the consumer 640. The producer 650 may apply different versions of AI/ML entity or capabilities on the scope profiles. As result of such evaluation for each AI/ML entities versions and scope profile, there will be associated performance metric. Based on such analysis the best performing pairs (AI/ML entity version, scope profile) can be determined. This information may be used for execution of activation request from consumer. This information may also include a switch-over between the AI/ML entity versions for different scope profiles.

The producer 650 may expose 622 the information on pairs 608 to the consumer 640. The consumer 640 may receive 632 the information on pairs 608 from the producer 650. If the best performing pairs 610 (AI/ML entity version, scope profile) have been applied for execution of activation request, the producer may inform the consumer 640 on successful activation of best performing pairs. The producer 650 may acknowledge 624 the activation of best performing pairs 610. The consumer 640 may receive 634 the activation of best performing pairs 610 from the producer 650.

If needed, the consumer 640 may update the activation request by specifying the AI/ML versions and scope profile pairs that shall be activated. The consumer 640 may send 636 the updated activation request 612 to the producer 650. The producer 650 may receive 638 the updated activation request 612 from the consumer 640.

In this manner, the scope profiles can be switched or applied one by one for different version of AI/ML entity in order to evaluate the performance of different versions under different scope characteristics. Therefore, by comparing such performance results, it is possible to determine which AI/ML entity performs the best under certain circumstances and to utilize such input for corresponding activation.

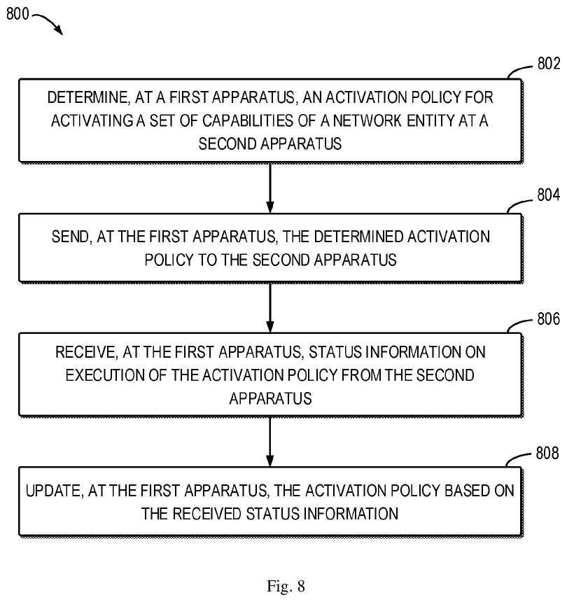

Reference is made to FIG. 8, which illustrates an example flowchart of a method 800 implemented at a first apparatus in accordance with some example embodiments of the present disclosure. The method 800 is described with reference to FIG. 1.

At block 802, the first apparatus 110 determines an activation policy for activating a set of capabilities of a network entity 130 at a second apparatus 120. At block 804, the first apparatus 110 sends the determined activation policy to the second apparatus 120. At block 806, the first apparatus 110 receives status information on execution of the activation policy from the second apparatus 120. At block 808, the first apparatus 110 updates the activation policy based on the received status information. It is noted that the method 800 may further include various other operations or steps performed by the first apparatus as described hereinbefore with reference to FIGS. 1-7.

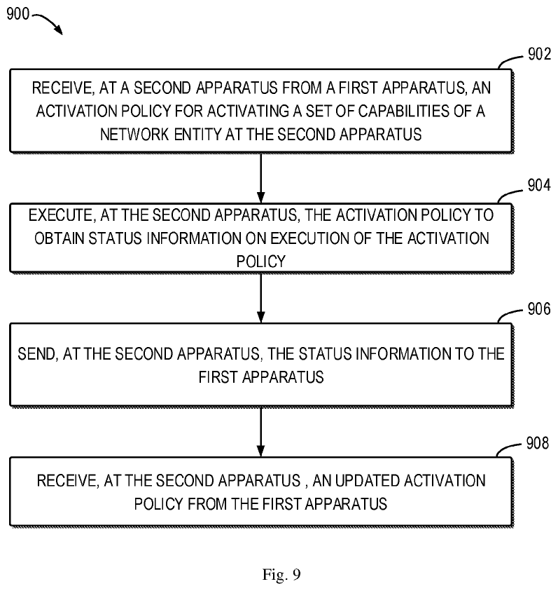

Reference is made to FIG. 9, which illustrates an example flowchart of a method 900 implemented at a second apparatus in accordance with some example embodiments of the present disclosure. The method 900 is described with reference to FIG. 1.

At block 902, the second apparatus 120 receives, from a first apparatus 110, an activation policy for activating a set of capabilities of a network entity 130 at the second apparatus 120. At block 904, the second apparatus 120 executes the activation policy to obtain status information on execution of the activation policy. At block 906, the second apparatus 120 sends the status information to the first apparatus 110. At block 908, the second apparatus 120 receives, from the first apparatus 110, an updated activation policy. It is noted that the method 900 may further include various other operations or steps performed by the second apparatus as described hereinbefore with reference to FIGS. 1-7.

By implementing the methods 800 or 900, a technical problem that how to enable the automated AI/ML capability activation can be solved. The methods 800 or 900 can also solve the technical problem that how to enable producer to perform gradual activation on behalf of AI/ML consumer. As such, it is possible to achieve higher level of automation in the AI/ML capabilities activation process. It is also possible to achieve less control on the activation process by an AI/ML consumer.

In some example embodiments, a first apparatus capable of performing the method 800 may comprise means for performing the respective steps of the method 800. The means may be implemented in any suitable form. For example, the means may be implemented in a circuitry or software module.

In some example embodiments, the first apparatus comprises: means for determining an activation policy for activating a set of capabilities of a network entity at a second apparatus; means for sending the determined activation policy to the second apparatus; means for receiving status information on execution of the activation policy from the second apparatus; and means for updating the activation policy based on the received status information.

In some example embodiments, the means for determining the activation policy comprise means for receiving, from the second apparatus, information on a plurality of capabilities of the network entity, the set of capabilities being at least part of the plurality of capabilities; and means for determining the activation policy based on the plurality of capabilities of the network entity.

In some example embodiments, the first apparatus is an artificial intelligence/machine learning (AI/ML) management service (MnS) consumer and the second apparatus is an AI/ML MnS producer; the network entity is an AI/ML entity; and the activation policy indicates a mode in which the first apparatus interacts with the second apparatus for the activation.

In some example embodiments, the set of capabilities are AI/ML capabilities, and an AI/ML capability description of the AI/ML capabilities comprises one or more of the following: one or more objects and/or object types for which the network entity is configured to undertake optimization or control; one or more parameters of the one or more objects and/or object types which the network entity is configured to control or optimize to achieve desired results; one or more metrics which the network entity is configured to undertake optimization; one or more objects and/or object types for which the network entity is configured to undertake analytics; or one or more network characteristics for which the network entity is configured to undertake analytics.

In some example embodiments, the activation policy is an activation policy step of a step-based policy.

In some example embodiments, the means for updating the activation policy comprise means for determining a next activation policy step of the step-based policy based on the status information on execution of at least one previous activation policy step.

In some example embodiments, the status information comprises one or more of the following: activation status; an activated AI/ML capability description; an activation scope description; or a report of metrics or changes as requested by the first apparatus.

In some example embodiments, the activation policy step is associated with one or more of the following: a set of AI/ML capabilities to be activated; an object or an objects type; a network context; an activation time window; or a network performance metric of interest to be monitored or reported.

In some example embodiments, the means for updating the activation policy step updates the activation policy step iteratively until one or more of the following: a desired capability in a desired scope is activated; or a desired metric is achieved.

In some example embodiments, the activation policy comprises a rule-based policy based on at least one activation rule.

In some example embodiments, the status information comprises a deviation in a metric of a condition for execution of the rule-based policy.

In some example embodiments, the at least one activation rule comprises one or more of the following: a complete set of AI/ML capabilities to be activated; a largest desired activation scope; a target activation scope; or an activation constraint or condition.

In some example embodiments, the activation constraint comprises one or more of the following: a network performance condition; an order of AI/ML capability activation; a priority of AI/ML capability activation; or a preference of time or geolocation for activation.

In some example embodiments, the means for updating the activation policy comprise means for following the at least one activation rule to activate the AI/ML capability until receiving a report of a deviation issue from the second apparatus; and updating the at least one activation rule based on the received report of the deviation issue.

In some example embodiments, the activation policy comprises an intent-based policy.

In some example embodiments, the status information comprises one or more of the following: information on a reached target for a network performance metric; or a deviation or inability in fulfilling an activation expectation.

In some example embodiments, the means for updating the activation policy comprise means for obtaining information on an achieved target for a network performance metric or a deviation in fulfilling the activation expectation; and means for updating the activation expectation based on the obtained information.

In some example embodiments, the activation policy comprises an activation request for activation of a version of the network entity or activation of at least one capability of the network entity in an activation scope.

In some example embodiments, the status information comprises performance of a plurality of versions of the network entity in different activation scopes.

In some example embodiments, a plurality of pairs of a version of the network entity and a scope profile are determined by the second apparatus by evaluation of performances of different versions of the network entity and different scope profiles.

In some example embodiments, the scope profile is determined based on at least one of the following scope dimensions: activation time; locations of apparatuses; objects; object types; or network contexts.

In some example embodiments, the means for updating the activation policy comprise means for sending, to the second apparatus, an indication of at least one pair of a version of the network entity and a scope profile to be activated.

In some example embodiments, the activation policy is one of a step-based policy, a rule-based policy and an intent-based policy, and the first apparatus further comprise means for switching over among the step-based policy, the rule-based policy and the intent-based policy based on an activation process preference change or a capability change.

In some example embodiments, a second apparatus capable of performing the method 900 may comprise means for performing the respective steps of the method 900. The means may be implemented in any suitable form. For example, the means may be implemented in a circuitry or software module.

In some example embodiments, the second apparatus comprises: means for receiving, from a first apparatus, an activation policy for activating a set of capabilities of a network entity at the second apparatus; means for executing the activation policy to obtain status information on execution of the activation policy; means for sending the status information to the first apparatus; and means for receiving an updated activation policy from the first apparatus.

In some example embodiments, the second apparatus further comprise means for sending, to the first apparatus, information on a plurality of capabilities of the network entity, the set of capabilities being at least part of the plurality of capabilities.

In some example embodiments, the first apparatus is an artificial intelligence/machine learning (AI/ML) management service (MnS) consumer and the second apparatus is an AI/ML MnS producer; the network entity is an AI/ML entity; and the activation policy indicates a mode in which the first apparatus interacts with the second apparatus for the activation.

In some example embodiments, the set of capabilities are AI/ML capabilities, and an AI/ML capability description of the AI/ML capabilities comprises one or more of the following: one or more objects and/or object types for which the network entity is configured to undertake optimization or control; one or more parameters of the one or more objects and/or object types which the network entity is configured to control or optimize to achieve desired results; one or more metrics which the network entity is configured to undertake optimization; one or more objects and/or object types for which the network entity is configured to undertake analytics; or one or more network characteristics for which the network entity is configured to undertake analytics.

In some example embodiments, the activation policy is an activation policy step of a step-based policy.

In some example embodiments, the status information comprises one or more of the following: activation status; an activated AI/ML capability description; an activation scope description; or a report of metrics or changes as requested by the first apparatus.

In some example embodiments, the activation policy step is associated with one or more of the following: a set of AI/ML capabilities to be activated; an object or an objects type; a network context; an activation time window; or a network performance metric of interest to be monitored or reported.

In some example embodiments, the activation policy comprises a rule-based policy based on at least one activation rule.

In some example embodiments, the status information comprises a deviation in a metric of a condition for execution of the rule-based policy.

In some example embodiments, the at least one activation rule comprises one or more of the following: a complete set of AI/ML capabilities to be activated; a largest desired activation scope; a target activation scope; or an activation constraint or condition.

In some example embodiments, the activation constraint comprises one or more of the following: a network performance condition; an order of AI/ML capability activation; a priority of AI/ML capability activation; or a preference of time or geolocation for activation.

In some example embodiments, the activation policy comprises an intent-based policy.

In some example embodiments, the status information comprises one or more of the following: information on a reached target for a network performance metric; or a deviation or inability in fulfilling an activation expectation.

In some example embodiments, the activation policy comprises an activation request for activation of a version of the network entity or activation of at least one capability of the network entity in an activation scope.

In some example embodiments, the status information comprises performance of a plurality of versions of the network entity in different activation scopes.

In some example embodiments, the the second apparatus further comprise means for determining a plurality of pairs of a version of the network entity and a scope profile; and means for evaluating performances of the plurality of pairs.

In some example embodiments, the scope profile is determined based on at least one of the following scope dimensions: activation time; locations of apparatuses; objects; object types; or network contexts.

In some example embodiments, the second apparatus further comprise means for receiving, from the first apparatus, an indication of at least one pair of a version of the network entity and a scope profile to be activated.

In some example embodiments, the activation policy is one of a step-based policy, a rule-based policy and an intent-based policy, and the second apparatus further comprise means for receiving, from the first apparatus, an indication indicating switching over among the step-based policy, the rule-based policy and the intent-based policy based on an activation process preference change or an AI/ML capability change.

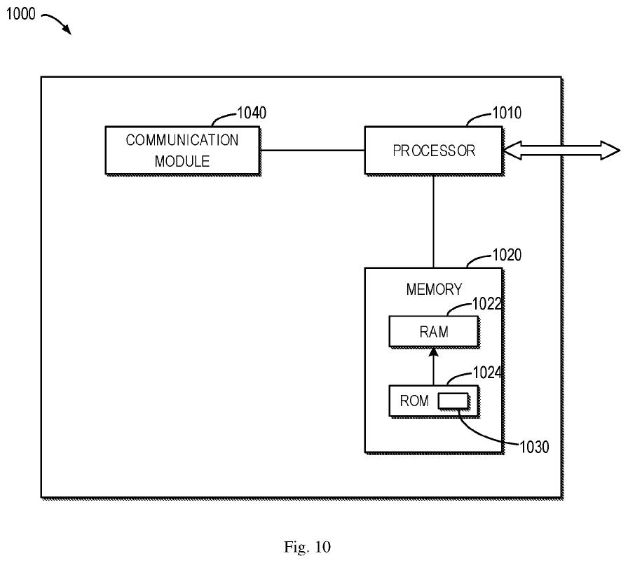

FIG. 10 is a simplified block diagram of a device 1000 that is suitable for implementing embodiments of the present disclosure. The device 1000 may be provided to implement the communication device, for example the first apparatus 110 or the second apparatus 120 as shown in FIG. 1. As shown, the device 1000 includes one or more processors 1010, one or more memories 1040 may couple to the processor 1010, and one or more communication modules 1040 may couple to the processor 1010.

The communication module 1040 is for bidirectional communications. The communication module 1040 has at least one antenna to facilitate communication. The communication interface may represent any interface that is necessary for communication with other network elements, for example the communication interface may be wireless or wireline to other network elements, or software based interface for communication.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a read only memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program so that the device 1000 may perform any process of the disclosure as discussed with reference to FIG. 2 to FIG. 9. The embodiments of the present disclosure may also be implemented by hardware or by a combination of software and hardware.

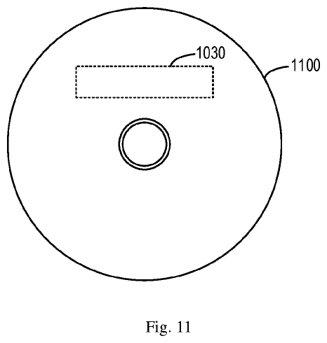

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 800 or 900 as described above with reference to FIG. 8 or FIG. 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

With some example embodiments of the present disclosure, related content of the corresponding 3GPP specification may be updated as follows.
5 Use cases, potential requirements and possible solutions
5.A Policy based AI/ML Activation
5.A.1 Description
TR 28.908 defines the AI/ML deployment as a process of making an AI/ML-enabled function available in the operational environments. After the training, the AI/ML-enabled function could be deployed in 3GPP system and subsequently activated. Current proposals for AI/ML entity activation assume that the activation of AI/ML capabilities will unconditionally improve the network performance. However, it is very difficult to “predict” the benefits and to quantify such benefits of using AI/ML capability in a given context of operational network, before using it. The solution for gradual activation of AI/ML capability provides the means to gradually “assess” the benefits of AI/ML capability activation in operational environment, but it opens the question on what is the most efficient split in responsibilities between consumer and producer during activation procedure.
5.A.2 Use cases
5.A.2.1 Enabling policy-based activation of AI/ML capabilities
If the activation procedure is entirely relying on the consumer to micro-manage every activation step, such process may require extensive signaling between the consumer and producer and intrinsically lacks the automation potential. On the other hand, the activation procedure cannot be left up fully to the producer either, as the producer may not have a “full picture” on other AI/ML entities/capabilities that are currently in operation, activated by different producers on the request from consumer. The producer needs to be instructed by the consumer on the ways to perform the adequate activation of AI/ML capabilities.
The activation may be instructed via one or more AI/ML activation policies, where an AI/ML activation policy is a sequence of tuples of conditions and activation settings that may be executed by the AI/ML producer. Conditions may define specific outcomes on performance metrics for which a particular activation may be executed while activation settings define specific attributes of the AI/ML capability activation scope, (e.g., object or object type, network context, activation time window) for which AI/ML should be activated.
5.A.3 Potential requirements
REQ-AI/MLUPDATE-1 the 3GPP management system shall have a capability to allow an authorized consumer to define the policies for activation of AI/ML capabilities in order to instruct the AI/ML MnS producer on how to perform the AI/ML activation (e.g., when and where to activate which AI/ML capabilities).
REQ-AI/MLUPDATE-2 the 3GPP management system shall have a capability to allow an authorized producer to activate the AI/ML capabilities based on the policies specified by the AI/ML MnS consumer.

### LIST OF ABBREVIATIONS

5GS 5G System
MnS Management Service
NWDAF Network Data Analytics Function
MDAS Management Data Analytics Service

1. A first apparatus comprising:
at least one processor; and
at least one memory storing instructions that, when executed by the at least one processor, cause the first apparatus to:
determine an activation policy for activating a set of capabilities of a network entity at a second apparatus;
send the determined activation policy to the second apparatus;
receive status information on execution of the activation policy from the second apparatus; and
update the activation policy based on the received status information.

2. The first apparatus of claim 1, wherein the first apparatus is caused to determine the activation policy by:
receiving, from the second apparatus, information on a plurality of capabilities of the network entity, the set of capabilities being at least part of the plurality of capabilities; and
determining the activation policy based on the plurality of capabilities of the network entity.

3. The first apparatus of claim 1, wherein:
the first apparatus is an artificial intelligence/machine learning (AI/ML) management service (MnS) consumer and the second apparatus is an AI/ML MnS producer;
the network entity is an AI/ML entity; and
the activation policy indicates a mode in which the first apparatus interacts with the second apparatus for the activation.

4. The first apparatus of claim 1, wherein the set of capabilities are AI/ML capabilities, and an AI/ML capability of the AI/ML capabilities comprises one or more of the following:
one or more objects and/or object types for which the network entity is configured to undertake optimization or control;
one or more parameters of the one or more objects and/or object types which the network entity is configured to control or optimize to achieve desired results;
one or more metrics which the network entity is configured to undertake optimization;
one or more objects and/or object types for which the network entity is configured to undertake analytics; or one or more network characteristics for which the network entity is configured to undertake analytics.

5. The first apparatus of claim 1, wherein the activation policy is an activation policy step of a step-based policy.

6. The first apparatus of claim 5, wherein the first apparatus is caused to update the activation policy by:
determining a next activation policy step of the step-based policy based on the status information on execution of at least one previous activation policy step.

7. The first apparatus of claim 5, wherein the status information comprises one or more of the following:
activation status;
an activated AI/ML capability description;
an activation scope description; or a report of metrics or changes as requested by the first apparatus.

8. The first apparatus of claim 5, wherein the activation policy step is associated with one or more of the following:
a set of AI/ML capabilities to be activated;
an object or an objects type;
a network context;
an activation time window; or
a network performance metric of interest to be monitored or reported.

9. The first apparatus of claim 5, wherein the first apparatus is further caused to update the activation policy step iteratively until one or more of the following:
a desired capability in a desired scope is activated; or
a desired metric is achieved.

10. The first apparatus of claim 1, wherein the activation policy comprises a rule-based policy based on at least one activation rule.

11-23. (canceled)

24. A second apparatus comprising:
at least one processor; and
at least one memory storing instructions that, when executed by the at least one processor, cause the second apparatus to:
receive, from a first apparatus, an activation policy for activating a set of capabilities of a network entity at the second apparatus;
execute the activation policy to obtain status information on execution of the activation policy;
send the status information to the first apparatus; and
receive an updated activation policy from the first apparatus.

25. The second apparatus of claim 24, wherein the second apparatus is further caused to:
send, to the first apparatus, information on a plurality of capabilities of the network entity, the set of capabilities being at least part of the plurality of capabilities.

26. The second apparatus of claim 24, wherein:
the first apparatus is an artificial intelligence/machine learning (AI/ML) management service (MnS) consumer and the second apparatus is an AI/ML MnS producer;
the network entity is an AI/ML entity; and
the activation policy indicates a mode in which the first apparatus interacts with the second apparatus for the activation.

27. The second apparatus of claim 24, wherein the set of capabilities are AI/ML capabilities, and an AI/ML capability of the AI/ML capabilities comprises one or more of the following:
one or more objects and/or object types for which the network entity is configured to undertake optimization or control;
one or more parameters of the one or more objects and/or object types which the network entity is configured to control or optimize to achieve desired results;
one or more metrics which the network entity is configured to undertake optimization;
one or more objects and/or object types for which the network entity is configured to undertake analytics; or
one or more network characteristics for which the network entity is configured to undertake analytics.

28. The second apparatus of claim 24, wherein the activation policy is an activation policy step of a step-based policy.

29. The second apparatus of claim 28, wherein the status information comprises one or more of the following:
activation status;
an activated AI/ML capability description;
an activation scope description; or
a report of metrics or changes as requested by the first apparatus.

30. The second apparatus of claim 28, wherein the activation policy step is associated with one or more of the following:
a set of AI/ML capabilities to be activated;
an object or an objects type;
a network context;
an activation time window; or
a network performance metric of interest to be monitored or reported.

31. The second apparatus of claim 24, wherein the activation policy comprises a rule-based policy based on at least one activation rule.

32. The second apparatus of claim 31, wherein the status information comprises a deviation in a metric of a condition for execution of the rule-based policy.

33. The second apparatus of claim 31, wherein the at least one activation rule comprises one or more of the following:
a complete set of AI/ML capabilities to be activated;
a largest desired activation scope;
a target activation scope; or
an activation constraint or condition.

34-47. (canceled)
